(19) United States
(12) Patent Application Publication
(10) Pub. No.: US 2010/0152935 A1
(43) Pub. Date: Jun. 17, 2010

(54) Restricting Unsupervised Activity of Unmanned Vessels

(76) Inventors: Lior Adjadj, Nahariya (IL); Yehuda Yosefi, Karmiel (IL); Eyal Wald, Timrat (IL)

Correspondence Address: YORAM TSIVION, P.O. BOX 1307, PARDES HANNA, 37111, IL

(21) Appl. No.: 12/295,724

(22) PCT Filed: Apr. 1, 2007
(86) PCT No.: PCT/IL07/00432

§ 371 Date: Oct. 2, 2008

(30) Foreign Application Priority Data
Apr. 2, 2006 (IL) 174723

(51) Int. Cl. G06F 19/00

(52) U.S. Cl. 701/21

(57) ABSTRACT

A process for balancing the execution of hazardous activity carried out in connection with an unmanned boat which is remotely controlled by two independent wireless communications channels. The process includes receiving signals from both communications channels. Subsequently, data is extracting from the two signals. After confirming the presence of two respective messages, one from each channel, a command is executed relating to safety issues, relating to the execution of the hazardous activity.

### FIELD OF THE INVENTION

The present invention relates to the safety of operations performed by an unmanned vessel for limiting potential hazardous activities of the vessel and the payload on board the vessel.

### BACKGROUND OF THE INVENTION

An unmanned marine vessel was described in PCT/IL2005/001329 by the same applicant. Such a marine vessel can carry a variety of payloads. These payloads may be related to any task which the vessel is to fulfill, civil, military, reconnaissance, or guard tasks or any combination thereof. Payload on board vessels may include potentially dangerous items or such that their activity may pose danger to intercepting vessels, other vehicles or otherwise susceptible property or personnel or the public in general. Most obviously offensive are weapons carried onboard unmanned vessels that are conditioned for firing.

Unmanned vessels can carry a variety of payloads some of which may be expected to function under a remote supervision of a control facility. In cases of remote supervision affected using wireless communication activity of an unmanned vessel, the communications system available is typically an electronic system suited for traversing the distance and complying with specific conditions that prevail between the transmitter and receiver. However, it is not unlikely that a wireless communications system, in some situations may become totally inactive or fail to deliver signals either way in a form suitable for processing and correct data extraction. It is expected that a small signal to noise ratio is expected to be a source of failing data transmission. Other sources of distraction are topographic affects of terrain existing between the sender and receiver, weather related atmospheric disturbances, and the proximity to either sender or receiver of foreign vessels. A different kind of interference may be brought about by hostile activities, intentional or unintentional. Typically, communications links channels employ various kinds of data integrity verification means. Most regularly used are redundancy checks that can detect flaws in data integrity received over the communications link.

### BRIEF DESCRIPTION OF THE DRAWINGS

FIG. 1 is a flow chart describing the succession of events implementing the condition of a presence of a second command for executing specific categorized actions on a vessel;

FIG. 2 is a flow chart describing the succession of events

FIG. 3 is a flow chart describing a concomitant reception of two related messages processed by the vessel in accordance with the invention.

### DETAILED DESCRIPTION OF THE PRESENT INVENTION

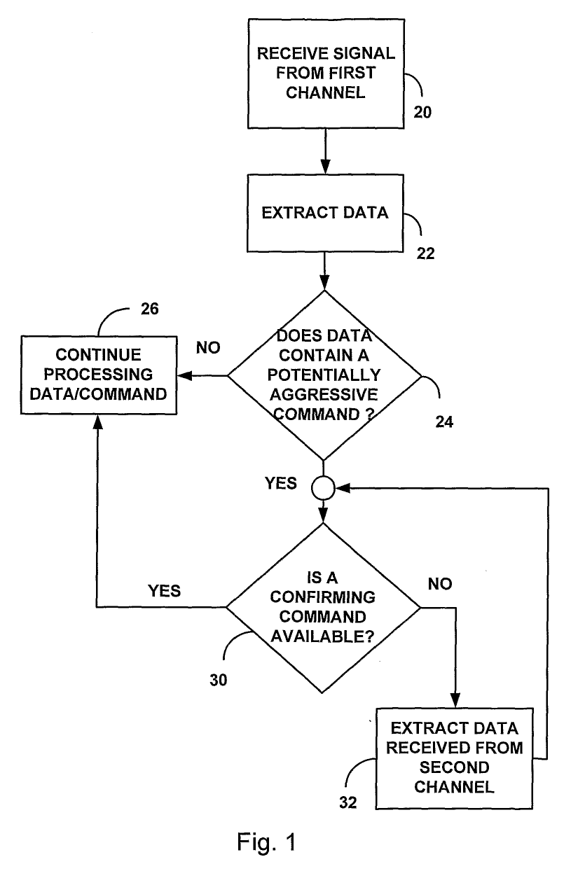

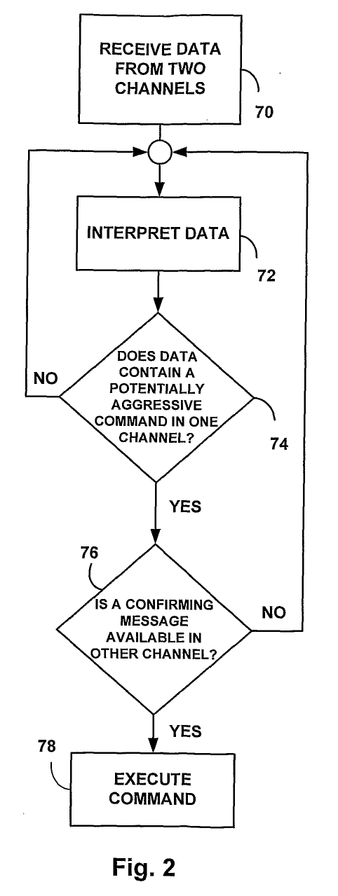

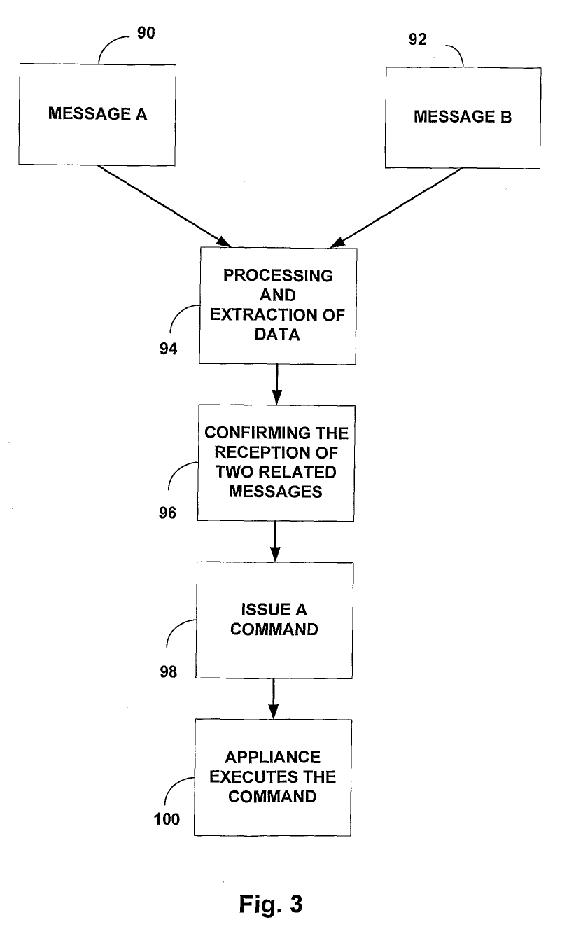

The method of the invention is applicable to unmanned vessels remotely supervised or controlled by a control facility utilizing communication channels. Whereas an unmanned vessel can be used as an offensive device, the benign activities of an unmanned vessel may become unintentionally involved in a hazardous activity. Some of the commands issued by the control facility that supervises the vessel's motion and other activities may be expected to refer to the performance of aggressive hazardous activities, for example aiming a weapon at a target. In accordance with the present invention, an unmanned vessel is to carry out commands relating to aggressive or hazardous activities only if an independent confirmation is received for each such command, thereby confirming the other command. An implementation of the invention described with reference to FIG. 1. In step 20 the unmanned vessel receives a signal from a control facility in a first channel of wireless communications. In step 22 the data is extracted, and in step 24 the vessel verifies whether the command is of aggressive consequences, typically such as starting a firing session. If it is categorized as non aggressive in step 26, the system of the vessel continues processing the command as programmed. On the other hand, if step 24 reveals that the command is of aggressive circumstances, the next step implemented is another verification step, 30, in which the system of the vessel is to verify the receipt of a confirming command relating to the same aggressive act, in a second independent wireless communications channel. If such is confirmed, the vessel continues processing the command in step 26. If on the other hand no confirming command is available, in step 32 the system of the vessel continues extracting data received from the second channel, returning to step 30. In one embodiment of the invention, the first and second channels differ among themselves in the frequency which the carrier signal is operating. In another embodiment, the two different channels are channels in a TDMA (time division multiple access) link. The reception and or extraction of the two complementary commands may be required to very closely match on the time axis or it may be synchronized by relative predefined or limited time delay. If the wireless communications channel uses time frames, the synchronization may be defined in terms of frames. A somewhat different set of considerations regarding the reception of signals from the control facility is described in FIG. 2 to which reference is now made. In step 70 data from two channels are received by the vessel, in step 72 the data is interpreted and if, in step 74, the data is found as containing a command of a potentially hazardous nature, the system goes through another verification step. Thus, in step 76 a confirming message is searched in a channel different than the channel in which the potentially hazardous command was sent. If such a message exists, the command defined earlier as potentially hazardous is executed in step 78. Several variations of the affirmation process proceeding towards execution of a command related to hazardous activity are discussed next. Put generally, two messages are to be received in order to bring the execution of a hazardous command into completion. In a preferred embodiment of the invention, the two messages referring to the same hazardous activity are to be carried over two distinctly different channels. In order to keep as general as possible, neither of the two messages is to be referred to as a command, thus the notion of a command may be realized only after the two related messages have been accepted and verified as being related to each other and also related to the same activity. Moreover, there is no requirement for any relative lag in time between the receipt of the two messages. To generalize schematically, reference is made to FIG. 3. Two messages, message 90 and message 92 are sent by the control facility and received by the vessel. The messages are extracted by a processing module 94 from the transmission of the control facility and further analyzed by a processing module 96 which may be the same one as the processing module indicated above. If the analysis step yields a result specifying the co-existence of two related messages related also to the performing of a hazardous activity, a module 98 of the vessel issues a command to be executed by the relevant appliance 100 on board the vessel.

The purpose for implementing the method of the invention is to prevent unnecessary hazardous actions taking place onboard or otherwise in connection with an unmanned vessel. Such hazardous actions may cause harm to payload on the vessel, structural or functional elements of the vessel, to other vessels or to any other object in reach of the vessel or its connected appliances. The definition of hazardous or aggressive action related to in this description encompass numerous activities all relating to a damage that may be inflicted by the vessel's subsystem or payload. Thus any activity which is to be accomplished in a succession of activities that culminates in a potentially hazardous event may be defined also as hazardous or aggressive. As an example, firing a machine gun is a culmination of a succession of activities, namely opening a breech, cocking a bolt, feeding rounds of ammunition, etc. Each of such activities may be benign in itself but the achievement of each and all of the activities culminates in a hazardous activity. Therefore, in accordance with the present invention, each such activity may be tagged as hazardous. Other hazardous activities on list are using a laser beam to measure distances or designate targets, cruising or maneuvering the vessel in the sea such that other objects as well as the vessel become exposed to mechanical damage. In another aspect of the invention, a vessel conducting continuous aggressive or hazardous activity may be programmed in advance for limiting the time period during which such an activity can continue. In such a case a recurring affirmation is to be obtained by the vessel in order to continue the hazardous activity beyond the limited time period prescribed automatically. In accordance with the present invention the recurring affirmation is to be sent over two distinct channels and applied mutatis mutandis.

### BENEFITS OF IMPLEMENTING THE METHOD OF THE INVENTION

Implementing the method of the invention aims at lowering the risk and increasing the safety of the unmanned vessel, associated payload and external objects. The unmanned vessel is linked typically to the control facility that communicates with the vessel sending data in which are conveyed information and commands. Data from the vessel sent uplink to the control facility carries information regarding the vessel's condition and information acquired by sensors on the vessel and in the payload, respectively. This information can be used as supervising tool to assess the nature and degree of safety risk associated with a specific hazardous activity to be performed in connection with the vessel. Other considerations may dictate automatic application of hazardous definitions on a specific activity without regarding the information received from the vessel. In any such case the process of the invention is applicable. The process of the invention does not replace regularly applied measures that protect integrity over communications links, notably, redundancy check known as checksum.

Other platforms which the present invention can be applied to are generally vehicles or unmanned land, space or aerial craft, unmanned watch posts etc. Moreover, even manned vehicles may be assisted by such a protective method provided by the present invention thereby freeing the crew from certain security considerations.

The two channels required for implementing the invention can be any separate independent channels as known in the art. For example, two channels using each a different carrier frequency. Alternatively two channels are defined as such wherein each such channel uses a different succession of time slots in a common TDMA (time domain multiple access) medium.

1. A process for affirming the execution of hazardous activity in connection with a vehicle remotely controlled by at least two independent wireless communications channels, said method comprising:
receiving signals from a first and a second communications channels;
extracting data from said signals;
confirming the presence of two messages, one from each channel, associated with hazardous activity within said data, and
executing said command.

2. A process for affirming the execution of hazardous activity in connection with a vehicle remotely controlled by at least two wireless communications channels as in claim 1 wherein said vehicle is a vessel.

3. A process for affirming the execution of hazardous activity in connection with a vehicle remotely controlled by at least two wireless communications channels as in claim 1 wherein said vehicle is an unmanned vessel.

4. A process for affirming the execution of hazardous activity in connection with a vehicle remotely controlled by at least two wireless communications channels as in claim 3 wherein said first and second wireless communications channels operate under different carrier frequencies.

5. A process for affirming the execution of hazardous activity in connection with an unmanned vessel remotely controlled by at least two wireless communications channels as in claim 3 wherein each channel occupies a different slot sequence in a TDMA wireless network.
